(19) United States
(12) Patent Application Publication
(10) Pub. No.: US 2011/0063194 A1
(43) Pub. Date: Mar. 17, 2011

(54) HEAD MOUNTED DISPLAY DEVICE

(75) Inventor: Rika NAKAZAWA, Nagoya-shi (JP)

(73) Assignee: BROTHER KOGYO KABUSHIKI KAISHA, Nagoya-shi, Aichi-ken (JP)

(21) Appl. No.: 12/884,109

(22) Filed: Sep. 16, 2010

(30) Foreign Application Priority Data
Sep. 16, 2009 (JP) 2009-215085

(51) Int. Cl. G09G 5/00

(52) U.S. Cl. 345/8

(57) ABSTRACT

A head mounted display device has an image display, an imager, and a processor. The image display displays a content image based on content data. The imager images an object based on an imaging command. The processor executes software units including, a display control unit, a first judgment unit. The display control unit is configured to control the image display such that the image display sequentially displays a plurality of content images, at least one of the plurality of content images being connected to the imaging command. The first judgment unit is configured to judge whether the imaging command is connected to one content image that is being displayed by the image display. The display control unit is configured to control the image display such that the image display displays another content image, when the first judgment unit judges that the imaging command is connected to the one content image, and when the imager images the object.

### CROSS REFERENCE TO RELATED APPLICATION

This application claims priority from Japanese Patent Application No. 2009-215085, filed on Sep. 16, 2009, the entire subject matter of which is incorporated herein by reference.

### BACKGROUND OF THE DISCLOSURE

1. Field of the Disclosure

The invention relates to a head mounted display device that displays a content image generated based on content data to a user.

2. Description of the Related Art

Compact apparatuses that display an image have been proposed. For example, a portable data display is proposed. This portable data display is connected to a digital camera, video camera, or memory card via a data conversion adapter. The portable data display displays images, which are memorized in the apparatus that connects to the data conversion adapter, on a data display. The data display is platelike, and hence it is light-weight and compact. The data conversion adapter is also light-weight and compact. Thus, the portable data display has three advantages: (1) facile portability, (2) little space for storing and installation, (3) reasonable manufacturing cost because of its simple structure (see e.g., JP-A-11-249589).

As an example of compact apparatuses that display an image, head mounted display devices (hereinafter interchangeably referred to as “HMDs”), which is mounted on a head of a user, have been proposed (see e.g., JP-A-2004-21931).

### SUMMARY OF THE DISCLOSURE

When a sequence of works including a plurality of processes is carried out, a worker may refer to a manual in which points of each process are written while the worker proceeds the sequence of works. In this case, for the purpose of efficient operation, it would be useful for the worker to display a content image, i.e., a page of the manual that includes a point of an ongoing process, in HMDs.

When each process has finished, the worker may images an object that is visible by his eyes, namely objects within a field of view of the worker. The image data would be benefit for a predetermined management. For example, objects and place related to a operation that is carried out by the worker are imaged, and it is confirmed whether the processes in the sequence of works are carried out preferably using the image data. In this case, the objects should be imaged at the end of each process.

Accordingly, it is an aspect of the present invention to provide a HMD that can prevent a user from missing out on imaging a predetermined object when a plurality of content images are sequentially displayed thereof.

In an embodiment of the invention, a head mounted display device comprises an image display displaying a content image based on content data, an imager imaging an object based on an imaging command, and a processor executing software units including, a display control unit configured to control the image display such that the image display sequentially displays a plurality of content images, at least one of the plurality of content images being connected to the imaging command; a first judgment unit configured to judge whether the imaging command is connected to one content image that is being displayed by the image display, wherein the display control unit is configured to control the image display such that the image display displays another content image, when the first judgment unit judges that the imaging command is connected to the one content image, and when the imager images the object.

According to another embodiment of the invention, a head mounted display device comprises an image display displaying a plurality of content images, an imager imaging an object based on an imaging command that is connected to at least one of the plurality of content images, and a processor executing software units including a first judgment unit configured to judge whether the imaging command is connected to one content image that is being displayed by the image display, and a display control unit configured to control the image display such that the image display sequentially displays the plurality of content images, the display control unit controlling the image display such that the image display displays another content image, when the first judgment unit judges that the imaging command is connected to the one content image, and when the imager images the object regarding to the one content image.

According to another embodiment of the invention, a head mounted display device comprises an image display displaying a plurality of content images regarding to different successive operations to be performed by an operator, an imager imaging an object based on an imaging command, the imaging command being connected to at least one of the plurality of content images, and a processor executing software units including a first judgment unit configured to judge whether the imaging command is connected to one content image that is being displayed by the image display regarding to one operation of the different successive operations, and a display control unit configured to control the image display so as to shift from displaying the one content image to displaying another content image following to the one content image, when the first judgment unit judges that the imaging command is connected to the one content image, and when the imager images the object in the one operation regarding to the one content image.

Other objects, features, and advantages of embodiments of the invention will be apparent to those skilled persons of ordinary skill in the art from the following detailed description and of embodiments with reference to the accompanying drawings.

### BRIEF DESCRIPTION OF THE DRAWINGS

For a more complete understanding of the invention, the needs satisfied thereby, and the objects, features, and advantages thereof, reference now is made to the following description taken in connection with the accompanying drawings.

FIG. 1 is a schematic view of a HMD, e.g., HMD 10, according to an embodiment of the invention.

FIG. 2A is a plan view of the HMD 10 according to an embodiment of the invention.

FIG. 2B is a front view of the HMD 10 according to an embodiment of the invention.

FIG. 2C is a left side view of the HMD 10 according to an embodiment of the invention.

FIG. 3 is a functional block diagram of the HMD 10 according to an embodiment of the invention.

FIG. 4 is a functional block diagram of an image display unit according to an embodiment of the invention.

FIG. 5 is a flow chart showing a content image display process of the HMD 10 according to an embodiment of the invention.

FIG. 6 is a schematic drawing showing a content image.

FIG. 7 is a schematic drawing showing a imaging command table.

FIG. 8 is a flow chart showing a content image display process of the HMD 10 according to another embodiment of the invention.

FIG. 9 is a schematic drawing showing a content image including an imaging command and a content image including a matching image.

### DESCRIPTION OF THE EMBODIMENTS

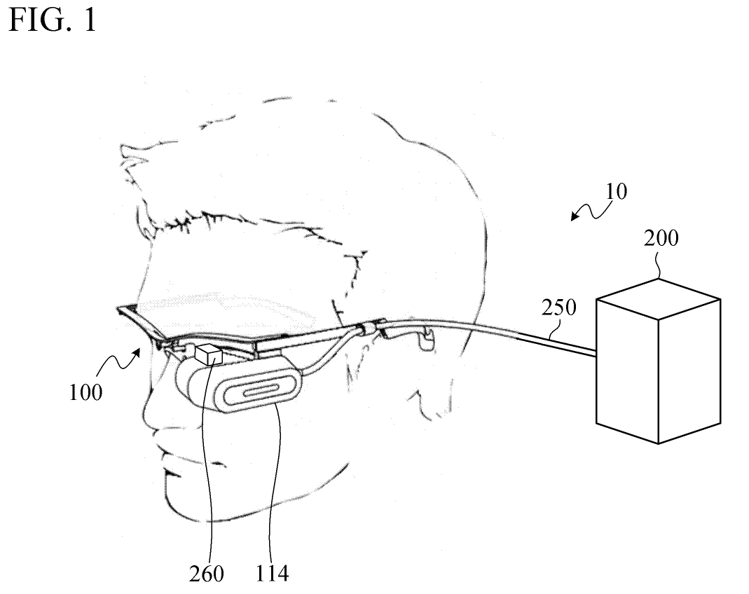

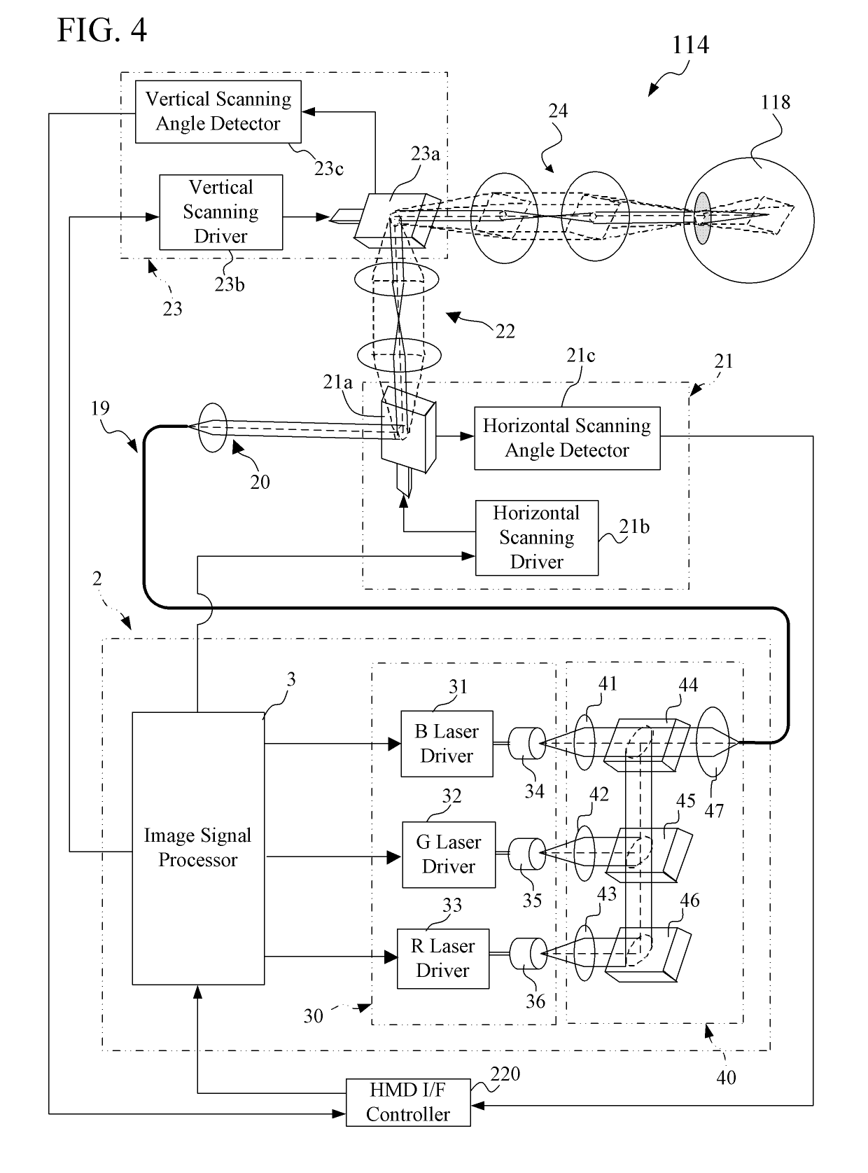

Embodiments of the invention and their features and technical advantages may be understood by referring to FIGS. 1-9, like numerals being used for like corresponding portions in the various drawings.

### <Mechanical Description of the HMD 10>

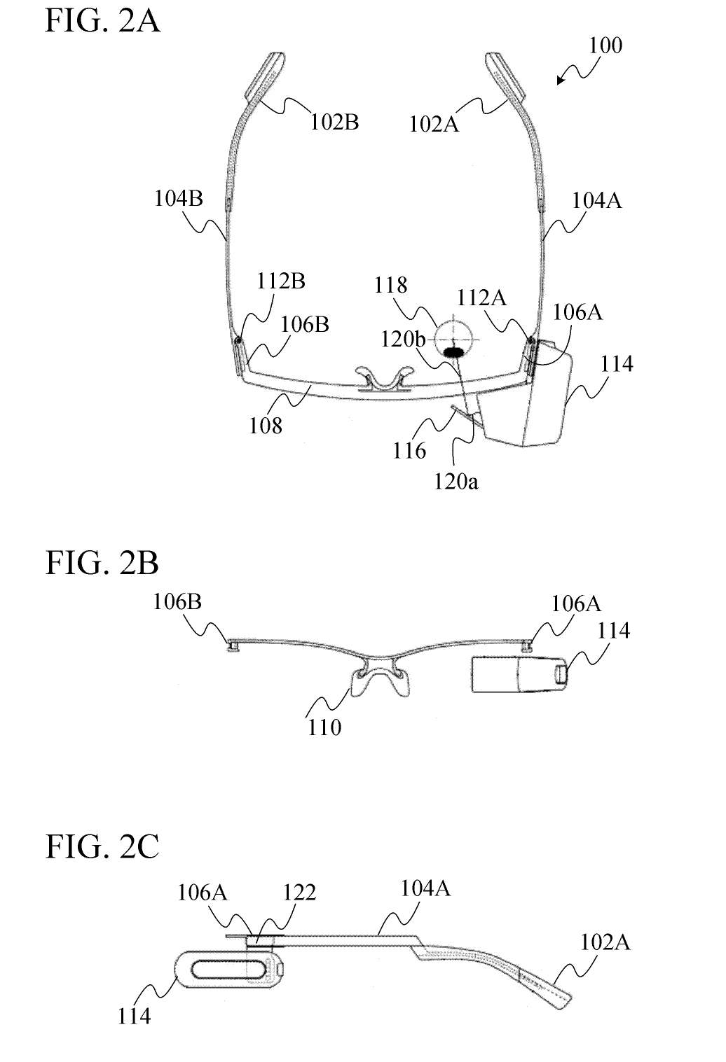

As shown in FIGS. 1 and 2, the HMD 10 may includes a HMD body 100 and a control box 200. The HMD body 100 is mounted on a head of a user. The control box 200 is mounted on any preferable portion of the user, e.g., a waist of the user.

The HMD body 100 may include a front frame 108, a left connection portion 106A, a right connection portion 106B, a left temple portion 104A, and a right temple portion 104B. The front frame 108 may include a nose pad 110, which contacts with a nose of the user, in the central portion thereof. The left connection portion 106A and the right connection portion 106B may be fixed to a left side edge and a right side edge of the front frame 108, respectively. One end portions of the left temple portions 104A and the right temple portion 104B may be rotatably connected to the connection portions 106A and 106B by a left hinge 112A and a right hinge 112B. A left ear pad 102A and a right ear pad 102B, which contact to ears of the user, may be fixed to the other end portions of the left temple portion 104A and the right temple portion 104B. Specifically, the left temple portion 104A and the right temple portion 104B may be rotatable around rotation axes that extend in the up-and-down direction of the left hinge 112A and the right hinge 112B, respectively. The front frame 108, the left connection portion 106A, the right connection portion 106B, the left temple portion 104A, and the right temple portion 104B may construct a skeleton of the HMD body 100 which is the same as that of an ordinal eyeglass. The HMD body 100 may be mounted on the head of the user by the left ear pad 102A, the right ear pad 102B, and the nose pat 110. Note that the left ear pad 102A, the right ear pad 102B, the left temple portion 104A, and the right temple portion 104B are omitted in FIG. 2B.

An image display 114 may be mounted on the skeleton of the HMD body 100 by an mounting member 122 that is mounted around the left connection portion 106A. When the image display 114 is mounted around the left connection portion 106A by the mounting member 122, it may be placed on a position that is level with a left eye 118 of the user who wears the HMD body 100. A charge-coupled device (CCD) sensor 260 may be fixed on an upper surface of the image display 114 (see FIG. 1). The image display 114 and the CCD sensor 260 may be connected to the control box 200 via a signal cable 250. The control box 200 may play (i.e., perform rendering process to) content data 2062 memorized in a predetermined memory area. Image signals, which includes a content image generated by the rendering process, may be sent to the image display 114 via the signal cable 250. The image display 114 may receive the image signals from the control box 200, and the image display 114 may project the content image, which is based on the image signals, to a half mirror 116.

An image light 120a, which represents the content image projected from the image display 114, may be reflected by the half mirror 116. A reflected image light 120b may enter the left eye 118, which allow the user to view the content image. Since the half mirror 116 may be configured to be translucent to visible wavelengths, the user may view the content image superimposed on background substances with the HMD body 100 mounted on the head of the user.

Various kind of displays, e.g., a liquid crystal display and an organic electroluminescent display, may be adopted as the image display 114. In this embodiment, a retinal scanning display may be adopted. That is, the image display 114 may two-dimensionally scan the image lights 110a, 110b, according to the image signals received thereby. The scanned image lights may enter the pupil of left eye 118, drawing the content image on the retina of the left eye 118.

### <Control Box 200>

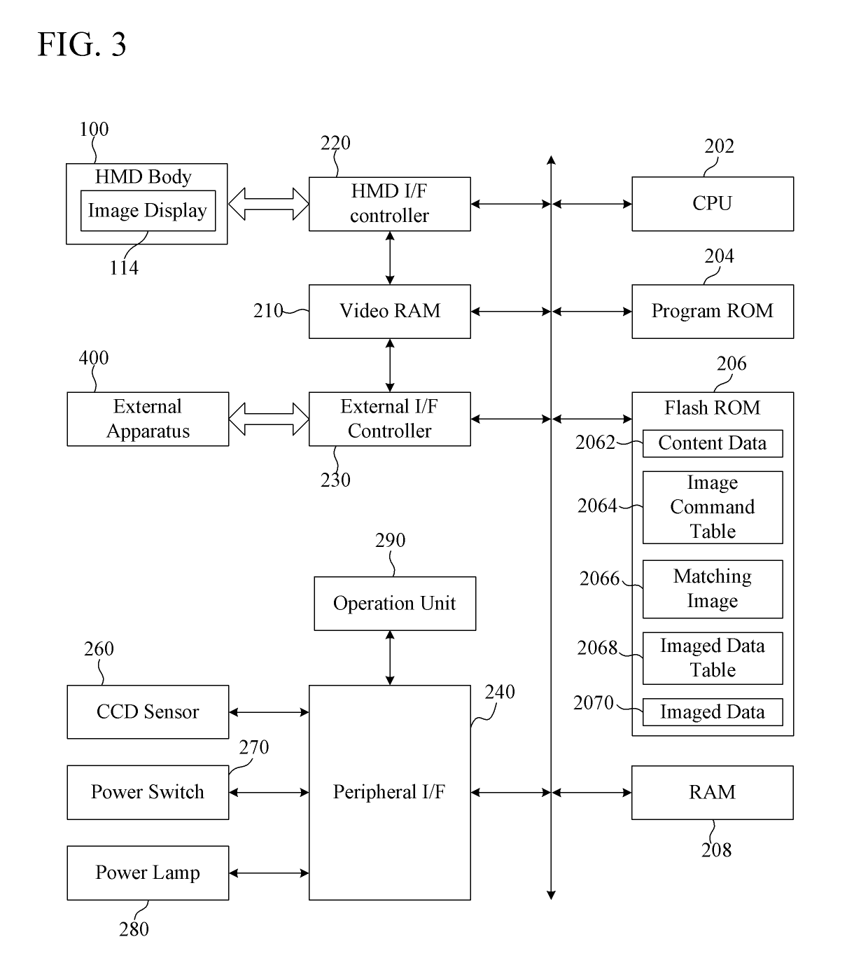

As shown in FIG. 3, the control box 200 may include a CPU 202 to control the control box 200, a program ROM 204 to memorize programs for various processes including a content image display process (see below), a flash RAM 206 which is nonvolatile, a RAM 208 as a working storage area. For example, the CPU 202 may execute a program for the content image display process, memorized in the program ROM 204, in the RAM 208. Various software units may be accomplished by the CPU 202 which executes various programs memorized in the program ROM 204. The flash RAM 206 may memorize content data 2062, an imaging command table 2064, a matching image 2066, an imaged data table 2068, and imaged data 2070.

The control box 200 may further include a video RAM 210, a HMD interface (I/F) controller 220, an external I/F controller 230, and a peripheral I/F 240. The video RAM 210 may be a frame memory that memorizes the content images that are generated by the rendering process and are received by an external apparatus 400. The HMD I/F controller 220 may be connected to the HMD body 100 via the signal cable 250. On the basis of commands from the CPU 202, the HMD I/F controller 220 may control input-output of various signals between the HMD body 100 and the image display 114. Specifically, the HMD I/F controller 220 may send to the image display 114 the image signals, which includes the content image, and a control signal for the image display 114. The external I/F controller 230 may be connected to the external apparatus 400, e.g., a personal computer, via a predetermined cable. The external I/F controller 230 may receive image signals from the external apparatus 400. The external I/F controller 230 may store content images based on the received image signals in the video RAM 210. The peripheral I/F 240 may be an interface device to which the CCD sensor 240, a power switch 270, a power lamp 280, and an operation unit 290 connect. The CPU 202 may receive a imaged data 2070 imaged by the CCD sensor 260 via the peripheral I/F 240. The user may switch the image display 114 and the control box 200 via the power switch 270. The power lamp 280 may light when the power switch is in the on position, and may be go off when the power switch is in the off position. The operation unit 290 may receive input of a predetermined command from the user. In other word, the user may input the predetermined command via the operation unit 290.

### <Image Display 114>

The image display 114 may include a light generator 2, an optical fiber 19, a collimate optical system 20, a horizontal scan unit 21, a first relay optical system 22, a vertical scan unit 23 and a second relay optical system 24. The light generator 2 may include an image signal processor 3, a light source unit 30 and an optical multiplexer 40. The image signal processor 3 may generate a B signal, a G signal, an R signal, a horizontal synchronizing signal and a vertical synchronizing signal, which are elements for composing the content image based on image signals supplied from the HMD I/F controller 220.

The light source unit 30 may include a B laser driver 31, a G laser driver 32, an R laser driver 33, a B laser 34, a G laser 35 and an R laser 36. The B laser driver 31 may drive the B laser 34 so as to generate blue light having intensity in accordance with a B signal from the image signal processor 3. The G laser driver 32 may drive the G laser 35 so as to generate green light having intensity in accordance with a G signal from the image signal processor 3. The R laser driver 33 may drive the R laser 36 so as to generate red light having intensity in accordance with an R signal from the image signal processor 3. The B laser 34, the G laser 35 and the R laser 36 may be configured by a semiconductor laser or a solid laser having harmonic producer.

The optical multiplexer 40 may include collimate optical systems 41, 42, 43 that collimate the laser light, dichroic mirrors 44, 45, 46 that multiplex the collimated laser light and a collecting optical system 47 that guides the multiplexed laser light to the optical fiber 19. The blue laser light emitted from the B laser 34 may be collimated by the collimate optical system 41 and then incident onto the dichroic mirror 44. The green laser light emitted from the G laser 35 may be collimated by the collimate optical system 42 and then incident onto the dichroic mirror 45. The red laser light emitted from the R laser 36 may be collimated by the collimate optical system 43 and then incident onto the dichroic mirror 46. The laser lights of three primary colors, which are respectively incident onto the dichroic mirrors 44, 45, 46, are reflected or transmitted in a wavelength selection manner and multiplexed into one light that is then incident onto the collecting optical system 47. The multiplexed laser light is collected by the collecting optical system 47 and then incident to the optical fiber 19.

The horizontal scan unit 21 may include a horizontal optical scanner 21a, a horizontal scanning driver 21b, and a horizontal scanning angle detector 21c. The horizontal scanning driver 21b may drive the horizontal optical scanner 21a in accordance with the horizontal synchronizing signal from the image signal processor 3. The horizontal scanning angle detector 21c may detect a rotational status of the horizontal optical scanner 21a, e.g., a rotational angle and a rotational frequency thereof. A signal that represents the rotational status, detected by the horizontal scanning angle detector 21c, may be transmitted to the HMD I/F controller 220, and may feed back to the horizontal synchronizing signal.

The vertical scan unit 23 may include a vertical optical scanner 23a, a vertical scanning driver 23b, and a vertical scanning angle detector 23c. The vertical scanning driver 23b may drive the vertical optical scanner 23a in accordance with the vertical synchronizing signal from the image signal processor 3. The vertical scanning angle detector 23c may detect a rotational status of the vertical optical scanner 23a, e.g., a rotational angle and a rotational frequency thereof. A signal that represents the rotational status, detected by the vertical scanning angle detector 23c, may be transmitted to the HMD I/F controller 220, and may feed back to the vertical synchronizing signal.

The laser light may be converted into a light horizontally and vertically scanned and then allowed to be projected as the content image by the horizontal optical scanner 21a and the vertical optical scanner 23a. Specifically, the laser light emitted from the optical fiber 19 may be converted into collimated light by the collimate optical system 20 and then guided to the horizontal optical scanner 21a. The laser light that is horizontally scanned by the horizontal optical scanner 21a may pass through the first relay optical system 22 and may be then incident on the vertical optical scanner 23a as parallel light. At this time, an optical pupil may be formed at the position of the optical vertical scanner 23a by the first relay optical system 22. The laser light, scanned vertically by the vertical optical scanner 23a, may pass through the second relay optical system 24 and may be then incident on the pupil of the left eye 118. Herein, the pupil of the left eye 118 and the optical pupil at the position of the vertical optical scanner 23a may have a conjugate relation by the second relay optical system 24.

In this embodiment, the laser light may be first horizontally scanned by the horizontal optical scanner 21a and then may be vertically scanned by the vertical optical scanner 23a. However, the horizontal optical scanner 21a and the vertical optical scanner 23a may be interchangeable each other. That is, the laser light may be first vertically scanned by the vertical optical scanner 23a and then may be horizontally scanned by the horizontal optical scanner 21a.

### <Content Image Display Process>

Here, two examples are explained as for content image display processes; one is related to manual imaging and another is related to automatic imaging. The content image display processes may be accomplished by the CPU 202 which executes dedicated programs for those processes, memorized in the program ROM 204, in the RAM 208. In these processes, the CPU 202 may use image data 2070 imaged by the CCD sensor 260 and like.

The content data 2062 may be data of a manual that explains assembly operations of a predetermined product. The content data 2062 may include a plurality of pages and each of the plurality of pages corresponds to each process of the assembly operation. The user who uses the HMD 10 may carry out the assembly operations with viewing a content image corresponding to each operation of the assembly operations. The user may input a command to start playing the content data 2062 by operating the operation unit 290. The CPU 202 may start a content image display processes, which is described below, in response to the command.

### <An Example of the Content Image Display Processes>

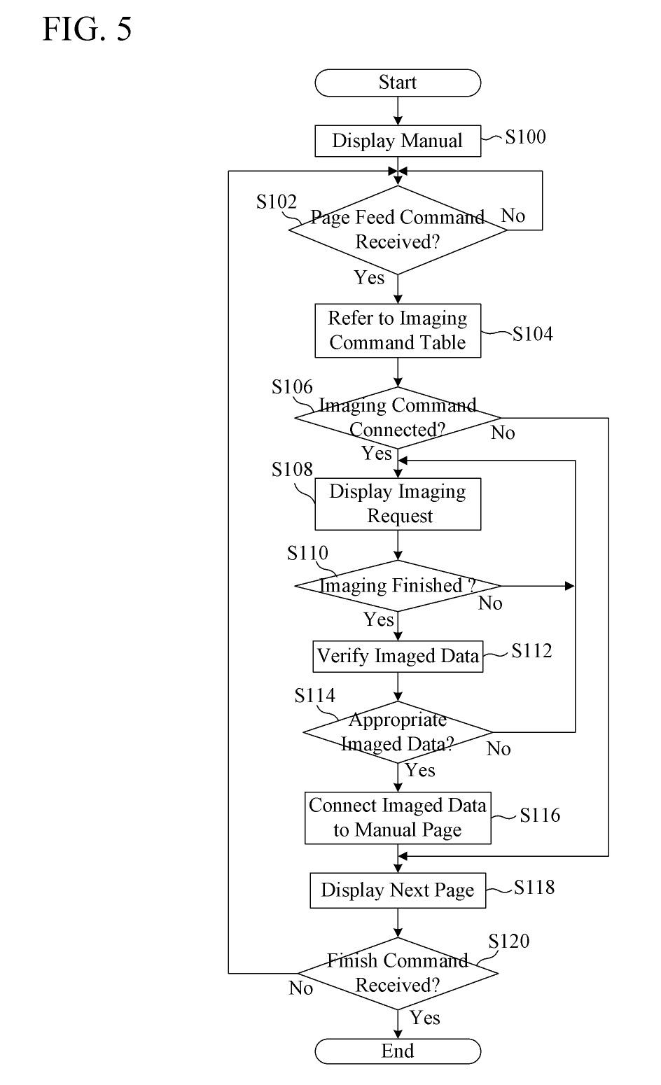

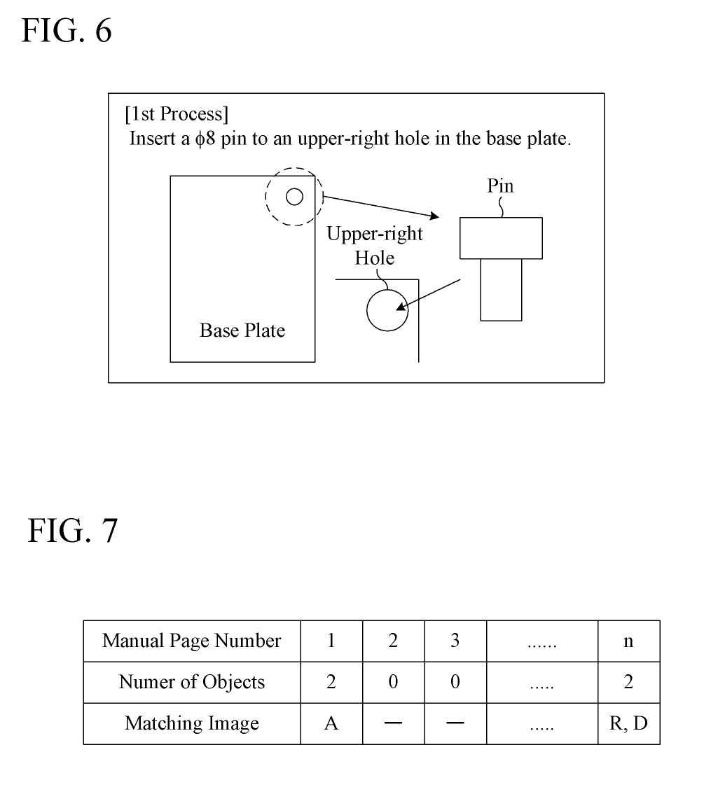

An example of the content image display processes may be explained with referring to FIGS. 5-7. The CPU 202, which starts the content image display process, may display a content image that shows a predetermined page of the manual showed by the content data 2062 (S100). For example, the CPU 202 may display a content image that shows the first page of the manual. As shown in FIG. 6, the content image may include text data and image data. The text data may be a text that explains inserting a □8 pin to an upper-right hole in the base plate. The image data may include an image of targets of the process such as a base plate, a hole, and a pin.

When the content image is displayed, the CPU 202 may load the content data 2062, memorized in the flash ROM 206, into the RAM 208. The CPU 202 may perform the rendering process to the content data 2062. The CPU 202 may store a content image, generated by the rendering process, in the video RAM 210. Otherwise, the CPU 202 may store a content image, received via the external I/F controller 230, to the video RAM 210. The CPU 202 may render the image display 114 displays the content image. That is, the CPU 202 may send image signals, which include the content image memorized in the video RAM 210, and control signals for displaying the content image to the image display 114 via the HMD I/F controller 220. These processes allow the user to view the content image.

In step S102, the CPU 202 may judge whether the user inputs a page feed command by operating the operation unit 290. If the page feed command is not input (i.e., S102: No), the CPU 202 may wait until the page feed command is input. On the other hand, If the page feed command is input (i.e., S102: Yes), the CPU may receive the page feed command. Then, the CPU 202 may refer to the imaging command table 2064 (see FIG. 7 for the details) that is memorized in the flash ROM 206 (S104).

The CPU 202 may judge whether a imaging command is connected to a page of the manual, shown by the content image displayed by the image display 114, in the imaging command table 2064 (S106). If an imaging command is connected to a page of the manual in the imaging command table 2064 (i.e., S106: Yes), the process may proceed to step S108. On the other hand, if a imaging command is not connected to a page of the manual in the imaging command table 2064 (i.e., S106: No), the process may proceed to step S118. When the step S106 is “No”, the CPU 202 may skip steps from S108 to S116. For example, according to the imaging command table 2064 in FIG. 7, when the first or nth page of the manual is displayed as the content image, the judgment in the step S106 is affirmative (S106: Yes). On the other hand, when pages of the manual except for the first or nth page are displayed as the content image, the judgment in the step S106 is negative (S106: No).

In step S108, The CPU 202 may render the image display 114 display a message that includes a imaging request to image an object. For example, a massage “Image the product that is in the middle of the assembling before the process proceeds.” may be displayed as a part of an image displayed by the image display 114. When a plurality of objects should be imaged, a massage, which means that each object should be imaged respectively, may be displayed. The CPU 202 may refer to the imaging command table 2064 to check the number of objects to be imaged for each page of the manual. When the first page of the manual is displayed as a content image, the CPU 202 may determine the number of objects to be images to be “one”. When the nth page of the manual is displayed as a content image, the CPU 202 may determine the number of objects to be images to be “two”.

In step S110, the CPU 202 may judge whether an object is imaged by the CCD sensor 260. The imaging of the object may be accomplished by the operation of the operation unit 290 by the user. The object may be a product that is in the middle of the assembling or a working area. When the imaging has not finished (S110: No), the CPU 202 may continue to display the content image, and the process backs to step S 108. Note that if there are a plurality of object to be imaged, a message, which means that all the objects should be imaged, may be displayed sequentially until all the objects are imaged. For example, a message, which means that one object should be imaged, may be displayed at first. When the object is imaged, another message, which means that another object should be imaged, may be displayed.

On the other hand, the imaging has finished for the object(s) (S110: Yes), the CPU 202 may verify the imaged data 2070 (S112). Specifically, the CPU 202 may judge whether the imaged data 2070 is a defocused image. Otherwise, when the matching image 2066, which is connected to each page of the manual, is recorded in the imaging command table 2064, the CPU 202 may compare the imaged data 2070 with the matching image 2066 that connects to a corresponding page of the manual. Specifically, the CPU 202 may judge whether a target, which is shown by the matching image 2066, is included as the object in the imaged data 2070. This judgment may be accomplished by a well-known pattern recognition process. The matching image 2066 is memorized in the flash ROM 206. When a plurality of the imaged data 2070 are imaged, the CPU 202 may judge the defocusing and the analogy of the corresponding matching image 2066 for each imaged data 2070. According to the imaging command table 2064 shown in FIG. 7, when the content image, which is displayed by the image display 114, means the first page of the manual, the CPU 202 may verify the first imaged data 2070a and the matching image 2066A. When the content image, which is displayed by the image display 114, means the nth page of the manual, the CPU 202 may verify the second imaged data 2070r and the matching image 2066R, and the CPU 202 may verify the third imaged data 2070d and the matching image 2066D.

In step S114, the CPU 202 may judge the result of the verification in step S112. If the imaged data 2070 is not appropriate, the process may back to step S108 and steps from S108 to S112 may be performed again. Note that when the number of the imaged data 2070 is plural, the judgment in step S114 may be negative if at least one of the imaged data 2070 is not appropriate. In this case, it may be possible to perform imaging for the imaged data 2070 that are not judged to be appropriate. On the other hand, if imaged data 2070 is appropriate (S114: Yes), the process may proceed to step S116. Note that the term “imaged data 2070 is appropriate” may mean that imaging condition of the imaged data 2070 is appropriate (e.g., clear focusing, not overexposure/underexposure), and when the matching image 2066 is recorded in the imaging command table 2064, the term may further mean that the imaged data 2070 and the matching image 2066 are analogous.

In step S116, the CPU 202 may connect the imaged data 2070 to the content image, specifically the manual page that is shown by the content image, displayed in step S110 or S118. The imaged data 2070 may be recorded in the imaged data table 2068, and hence memorized in the flash ROM 206. For example, when the first page of the manual is displayed, the CPU 202 may connect the first imaged data 2070a to the first page of the imaged data table 2068 to record thereof, and hence memorize the first imaged data 2070a to the flash ROM 206. When the nth page of the manual is displayed, the CPU 202 may connect the second imaged data 2070r and the third imaged data 2070r to the nth page of the imaged data table 2068 to record thereof, and hence memorize the second imaged data 2070r and the third imaged data 2070r to the flash ROM 206. Then the process may proceed to step S118.

In step S118, the CPU 202 may display the next page of the manual. For example, when a content image that means the first page of the manual is displayed, a content image that means second page of the manual may be displayed. In step S120, the CPU 202 may judge whether a finish command is received. The finish command in step S120 may be generated by inputting a finish input to the operation unit 290 by the user. If the finish command is not received (S120: No), the process may back to step S104. On the other hand, the finish command is received (S120: Yes), process may terminate.

### <Another Example of the Content Image Display Processes>

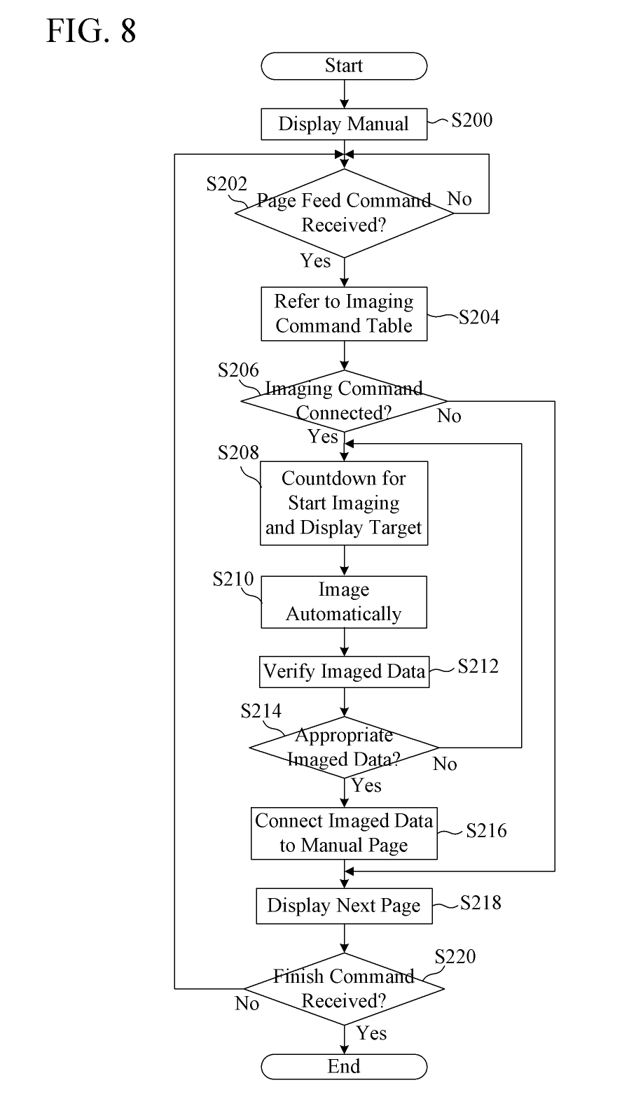

Another example of the content image display processes may be explained with referring to FIG. 8. The CPU 202, which starts the content image display process, may perform steps from S200 to S206 sequentially. Here, steps from S200 to S206 correspond to steps from S100 to S106 shown in FIG. 5. Thus, explanations of steps from S200 to S206 are omitted. Note that the process may proceed to step S208 if the judgment of step S206 is affirmative (S206: Yes), and the process may proceed to step S218 without performing steps from S208 to S216 if the judgment of step S206 is negative (S206: No).

In step S208, the CPU 202 may display a message that includes count down to image (i.e., residual seconds to start imaging) and an image of a target to be imaged as an object. In this message, a message may include the message that urges the user to look at the object by the left eye 118. Since the CCD sensor 260 may be fixed on an upper surface of the image display 114, preferable imaging may be performed by including such a message. When the time has come to image, the CPU 202 may render the CCD sensor 260 image automatically (S210). If a plurality of objects to be imaged is recorded as for the content image displayed, such as the nth page of the manual, the step S208 and S210 may be iterated for each of the object.

After the object is imaged in step S210, the CPU 202 may perform steps from S212 to S220 sequentially. Here, steps from S212 to S220 correspond to steps from S112 to S120 shown in FIG. 5. Thus, explanations of steps from S212 to S220 are omitted.

<Advantages of the embodiment>

In the embodiment above, when an imaging of a certain object is required (S106: Yes in FIGS. 5 and S206: Yes in FIG. 8) as for a page of the manual shown by a content image displayed by the image display 114 (S100 and S118 in FIGS. 5 and S200 and S218 in FIG. 8), a content image that shows the next page of the manual may be displayed (S118 in FIGS. 5 and S218 in FIG. 8) if an appropriate imaged data 2070 is obtained (S114: Yes in FIGS. 5 and S214:Yes in FIG. 8). Thus, the appropriate imaged data 2070, which includes the object, can be obtained. In other word, forgetting to image the object and obtaining the inappropriate imaged data 2070 can be avoided.

When it is required to check whether all the assembly processes of a predetermined product have preferably finished, an imaging of a specific object may be required. In this case, the user can confirm all the assembly processes by the imaged data 2070 after he has finished all the assembly processes.

In an embodiment above, the HMD body 100 and the control box 200, which are elements of the HMD 10, may be separated. However, a HMD may include the HMD body 100 and the control box 200 in an integrated manner. In this case, each element of the control box 200 (see FIG. 3) may be contained in a chassis of the image display unit 114.

In an embodiment above, the image command table 2064 (see FIG. 7) may be used in step S106 (see FIG. 5). That is, in step S106, the CPU 202 may judge whether a imaging command is connected to a page of the manual, shown by the content image displayed by the image display 114, in the imaging command table 2064. If the judgment if affirmative (i.e., S106: Yes), the object may be imaged (S108), the imaged data 2070 may be verified based on the matching image 2066, and (S112), and the appropriateness of the imaged data 2070 may be judged (S114). On the other hand, if the judgment is negative (i.e., S106: No), the process may proceed to step S118 without performing steps from S108 to S116.

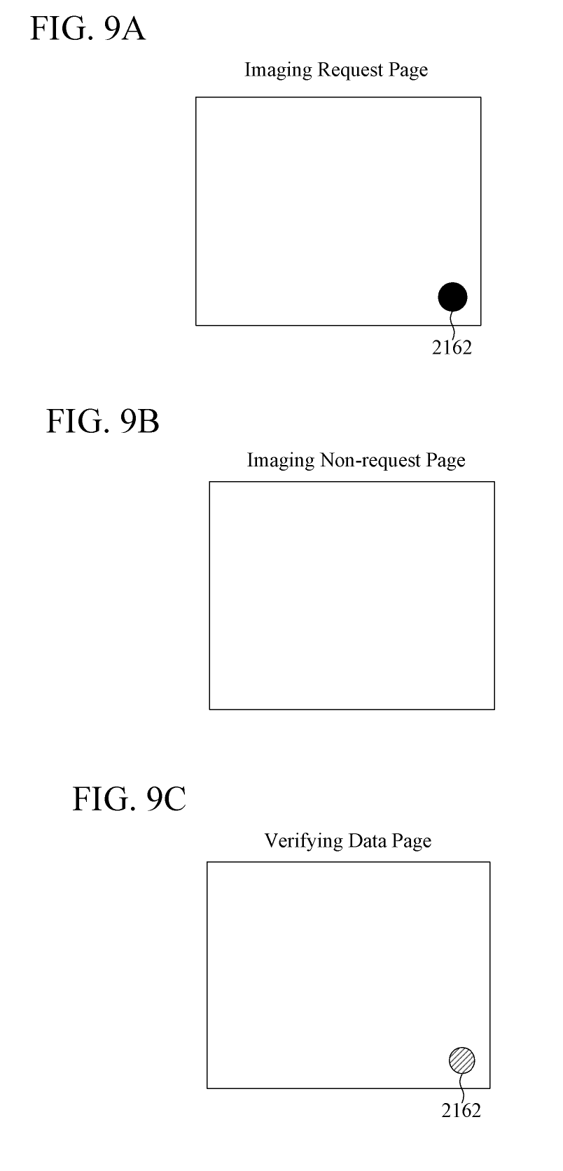

Here, steps S106, S112 and S114 may be accomplished by using a content image and a matching image, both are shown in FIGS. 9A-9C, that include imaging commands without the image command table 2064. Specifically, in step S106, the CPU 202 may judge whether a specific object is located in a predetermined position of a content image which is displayed in the image display 114. When an object 2162 is located in a lower-right area of the content image, as shown in FIG. 9A, the judgment in S106 may be affirmative (S106: Yes). On the other hand, when an object 2162 is not located in a lower-right area of the content image, as shown in FIG. 9B, the judgment in S106 may be negative (S106: No).

In steps S112 and S114, content data may include specific data that shows a matching image. In this case, the judgment of the appropriateness of the imaged data 2070 may be accomplished by comparing the matching image included in the content data and the imaged data 2070. Specifically, a matching image that is identical with an object may be placed in the next page of a content image that shows a manual page in which the object 2162, which indicates an imaging command, is included as shown in FIG. 9A.

As shown in FIG. 9C, the matching image may include an object 2262 in a lower right area thereof. The object 2262 may be different from the object 2162 in configurations such as shape, colors, and patterns. The CPU 202 may verify the matching image on the basis of the object 2262. Then, after the CPU 202 finishes imaging (S110), the CPU 202 may compare the imaged data 2070 with the matching image (S112), and thereby may judge whether the imaged data 2070 is appropriate (S114). The CPU 202 may control the HMD 10 such that the matching data is not displayed in step S118. This can be applied to steps in S208, S212 and S212.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A head mounted display device comprising:
an image display displaying a content image based on content data;
an imager imaging an object based on an imaging command; and
a processor executing software units including:
a display control unit configured to control the image display such that the image display sequentially displays a plurality of content images, at least one of the plurality of content images being connected to the imaging command; and
a first judgment unit configured to judge whether the imaging command is connected to one content image that is being displayed by the image display,
wherein the display control unit is configured to control the image display such that the image display displays another content image, when the first judgment unit judges that the imaging command is connected to the one content image, and when the imager images the object.

2. The head mounted display device according to claim 1, further comprising:
a second judgment unit configured to judge whether the image data that includes the object imaged by the imager is appropriate, and
wherein the display control unit controls the image display such that the image display displays another content image , when the second judgment unit judges that the image data is appropriate.

3. The head mounted display device according to claim 2,
wherein the second judgment unit judges that the image data is appropriate when a predetermined target is included as the object in the image data, and the second judgment unit judges the image data is not appropriate when a predetermined target is not included as the object in the image data.

4. The head mounted display device according to claim 1, further comprising:
a first connection unit configured to connect the image data that includes the object imaged by the imager to the one content image.

5. The head mounted display device according to claim 1, further comprising:
a second connection unit configured to connect the imaging command to each content image for which the imager images the object while the image display displays the content image, and
wherein the first judgment unit judges that the imager images the object when the imaging command is connected to the one content image by the second connection unit, and the first judgment unit judges that the imager does not image the object when the imaging command is not connected to the one content image by the second connection unit.

6. The head mounted display device according to claim 1, further comprising:
an imaging control unit configured to control the imager such that the imager images the object, when the first judgment unit judges that the imaging command is connected to the one content image.

7. A head mounted display device comprising:
an image display displaying a plurality of content images;
an imager imaging an object based on an imaging command that is connected to at least one of the plurality of content images; and
a processor executing software units including:
a first judgment unit configured to judge whether the imaging command is connected to one content image that is being displayed by the image display; and
a display control unit configured to control the image display such that the image display sequentially displays the plurality of content images, the display control unit controlling the image display such that the image display displays another content image, when the first judgment unit judges that the imaging command is connected to the one content image, and when the imager images the object regarding to the one content image.

8. A head mounted display device comprising:
an image display displaying a plurality of content images regarding to different successive operations to be performed by an operator;
an imager imaging an object based on an imaging command, the imaging command being connected to at least one of the plurality of content images; and
a processor executing software units including:
a first judgment unit configured to judge whether the imaging command is connected to one content image that is being displayed by the image display regarding to one operation of the different successive operations,; and
a display control unit configured to control the image display so as to shift from displaying the one content image to displaying another content image following to the one content image, when the first judgment unit judges that the imaging command is connected to the one content image, and when the imager images the object in the one operation regarding to the one content image.

9. A head mounted display device according to claim 1, further comprising:
a table memory storing connection relation between the imaging command and at least one of the plurality of content images, and
wherein the first judgment unit judges whether the imaging command is connected to the one content image, based on the connection relation stored by the table memory.

10. A head mounted display device according to claim 1, further comprising:
a manual member operable by an operator to shift the content image to be displayed, and
wherein the first judgment unit judges whether the imaging command is connected to the one content image, when the manual member is operated by the operator.

11. A head mounted display device according to claim 1,
wherein a plurality of objects to be imaged by the imager are included in at least one operation of the different successive operations, and
wherein the display control controls the image display so as to shift from displaying the one content image to displaying another content image following to the one content image, when the first judgment unit judges that the imaging command is connected to the one content image, and when the imager images all of the objects included in the one operation regarding to the one content image.
